(19) United States
(12) Patent Application Publication
(10) Pub. No.: US 2010/0250116 A1
(43) Pub. Date: Sep. 30, 2010

(54) NAVIGATION DEVICE

(76) Inventors: Yoshihisa Yamaguchi, Tokyo (JP); Takashi Nakagawa, Tokyo (JP); Toyoaki Kitano, Tokyo (JP); Hideto Miyazaki, Tokyo (JP); Tsutomu Matsubara, Tokyo (JP); Katsuya Kawai, Tokyo (JP)

Correspondence Address: BIRCH STEWART KOLASCH & BIRCH, PO BOX 747, FALLS CHURCH, VA, 22040-0747, US

(21) Appl. No.: 12/742,776

(22) PCT Filed: Sep. 10, 2008
(86) PCT No.: PCT/JP2008/002502

§ 371 Date: May 13, 2010

(30) Foreign Application Priority Data
Dec. 28, 2007 (JP) 2007-339849

(51) Int. Cl. G01C 21/36

(52) U.S. Cl. 701/201

(57) ABSTRACT

A navigation device includes: a map database 5 that holds map data; a location and heading measurement unit 4 that measures the current location and heading of a vehicle; a route calculation unit 12 that, based on the map data read from the map database, calculates a guidance route from the current location measured by the location and heading measurement unit to a destination; a camera 7 that captures video images ahead of the vehicle; a video image acquisition unit 8 that acquires the video images ahead of the vehicle captured by the camera; a side road acquisition unit 16 that acquires a side road connected at a location between the current location on the guidance route calculated by the route calculation unit and a guidance waypoint; a video image composition processing unit 14 that composes a picture representing the side road acquired by the side road acquisition unit onto the video images acquired by the video image acquisition unit; and a display unit 10 that displays the video image composed by the video image composition processing unit in a superimposing manner.

### TECHNICAL FIELD

The present invention relates to a navigation device that guides a user to a destination, and more particularly to a technology for displaying guidance information on a live-action or real video image that is captured by a camera.

### BACKGROUND ART

Known technologies in conventional car navigation devices include, for instance, route guidance technologies in which an on-board camera captures images ahead of a vehicle during cruising, and guidance information, in the form of CG (Computer Graphics), is displayed with being overlaid on video obtained through the above image capture (for instance, Patent Document 1).

Also, as a similar technology, Patent Document 2 discloses a car navigation device in which navigation information elements are displayed so as to be readily grasped intuitively. In this car navigation device, an imaging camera attached to the nose or the like of a vehicle captures the background in the travel direction, in such a manner that a map image and a live-action video image, for background display of navigation information elements, can be selected by a selector, and the navigation information elements are displayed overlaid on the background image, on a display device, by way of an image composition unit. Patent document 2 discloses a technology wherein, during guidance of a vehicle along a route, an arrow is displayed using a live-action video image, at intersections along the road in which the vehicle is guided.

Route guidance using live-action video images according to the technologies set forth in Patent document 1 and Patent document 2 above, however, is problematic in that the captured video images are two-dimensional. The displayed appearance differs thus from the actual scenery ahead, and is poor in depth feel.

To deal with the above issue, Patent document 3 discloses a navigation device in which display is carried out in such a manner that the feeling of distance up to a guide point (for instance, an intersection to which a vehicle is guided) can be determined intuitively and instantaneously. In this navigation device, the shape and color of an object such as an arrow or the like that is displayed on live-action video images in a superimposing manner is changed in accordance with the distance to a guide point. The object may be a plurality of objects, and may be displayed on live-action video images.

Patent document 1: Japanese Patent No. 2915508

Patent document 2: Japanese Patent Application Laid-open No. 11-108684 (JP-A-11-108684)

Patent document 3: Japanese Patent Application Laid-open No. 2007-121001 (JP-A-2007-121001)

In the technology disclosed in Patent document 3, thus, changes are performed in accordance with the color or shape of an object, but no consideration is given to the shape of a guidance route up to a guide point. As a result, the same guidance is displayed when distances are identical, regardless of whether easily confused roads, such as side roads, are present or not on the guidance route up to the guide point. In consequence, the user may turn at a wrong intersection ahead.

The present invention is made to solve the aforementioned problem, and it is an object of the present invention to provide a navigation device capable of displaying side roads in an easy-to-grasp manner.

### DISCLOSURE OF THE INVENTION

In order to solve the above problem, a navigation device according to the present invention includes: a map database that holds map data; a location and heading measurement unit that measures a current location and heading of a vehicle; a route calculation unit that, based on the map data read from the map database, calculates a guidance route from the current location measured by the location and heading measurement unit to a destination; a camera that captures a video image ahead of the vehicle; a video image acquisition unit that acquires the video image ahead of the vehicle that is captured by the camera; a side road acquisition unit that acquires a side road connected at a location between the current location on the guidance route calculated by the route calculation unit and a guidance waypoint; a video image composition processing unit that composes a picture representing the side road that is acquired by the side road acquisition unit onto the video image acquired by the video image acquisition unit in a superimposing manner; and a display unit that displays the video image composed by the video image composition processing unit.

According to the navigation device of the present invention, when guidance information is superimposed and displayed on a video image of vehicle surroundings obtained through the capture by the camera, there are displayed side roads that are present on a guidance route up to a guidance waypoint. Thus, side roads can be displayed in an easy-to-grasp manner, and the likelihood of wrong turning at an intersection ahead can be reduced.

### BRIEF DESCRIPTION OF THE DRAWINGS

FIG. 1 is a block diagram illustrating the configuration of a car navigation device according to Embodiment 1 of the present invention;

FIG. 2 is a flowchart illustrating the operation of the car navigation device according to Embodiment 1 of the present invention, focusing on a vehicle surroundings information display process;

FIG. 3 is a flowchart illustrating the details of a content-composed video image creation process that is carried out in the vehicle surroundings information display process of the car navigation device according to Embodiment 1 of the present invention;

FIG. 4 is a flowchart illustrating the details of a content creation process that is carried out during the content-composed video image creation process in the vehicle surroundings information display process of the car navigation device according to Embodiment 1 of the present invention;

FIG. 5 is a flowchart illustrating the details of a content creation process of road information that is carried out in the content creation process during the content-composed video image creation process in the vehicle surroundings information display process of the car navigation device according to Embodiment 1 of the present invention;

FIG. 6 is a diagram illustrating an example of a video image displayed on the screen of a display unit of the car navigation device according to Embodiment 1 of the present invention;

FIG. 7 is a block diagram illustrating the configuration of a car navigation device according to Embodiment 2 of the present invention;

FIG. 8 is a diagram illustrating an example of a video image displayed on the screen of a display unit in the car navigation device according to Embodiment 2 of the present invention;

FIG. 9 is a set of diagrams illustrating an example of a video image displayed on the screen of a display unit in the car navigation device according to Embodiment 3 of the present invention;

FIG. 10 is a block diagram illustrating the configuration of a car navigation device according to Embodiment 4 of the present invention;

FIG. 11 is a flowchart illustrating the details of a content creation process of road information that is carried out in the content creation process during the content-composed video image creation process in the vehicle surroundings information display process of the car navigation device according to Embodiment 4 of the present invention;

FIG. 12 is a diagram illustrating an example of a video image displayed on the screen of a display unit in the car navigation device according to Embodiment 4 of the present invention;

FIG. 13 is a diagram illustrating an example of a video image displayed on the screen of a display unit in the car navigation device according to Embodiment 5 of the present invention;

FIG. 14 is a block diagram illustrating the configuration of a car navigation device according to Embodiment 6 of the present invention;

FIG. 15 is a set of diagrams illustrating an example of a video image displayed on the screen of a display unit in the car navigation device according to Embodiment 6 of the present invention;

FIG. 16 is a block diagram illustrating the configuration of a car navigation device according to Embodiment 7 of the present invention; and

FIG. 17 is a set of diagrams illustrating an example of a video image displayed on the screen of a display unit in the car navigation device according to Embodiment 7 of the present invention.

### BEST MODE FOR CARRYING OUT THE INVENTION

The present invention is explained in detail below on the basis of preferred embodiments for realizing the invention, with reference to accompanying drawings.

### Embodiment 1

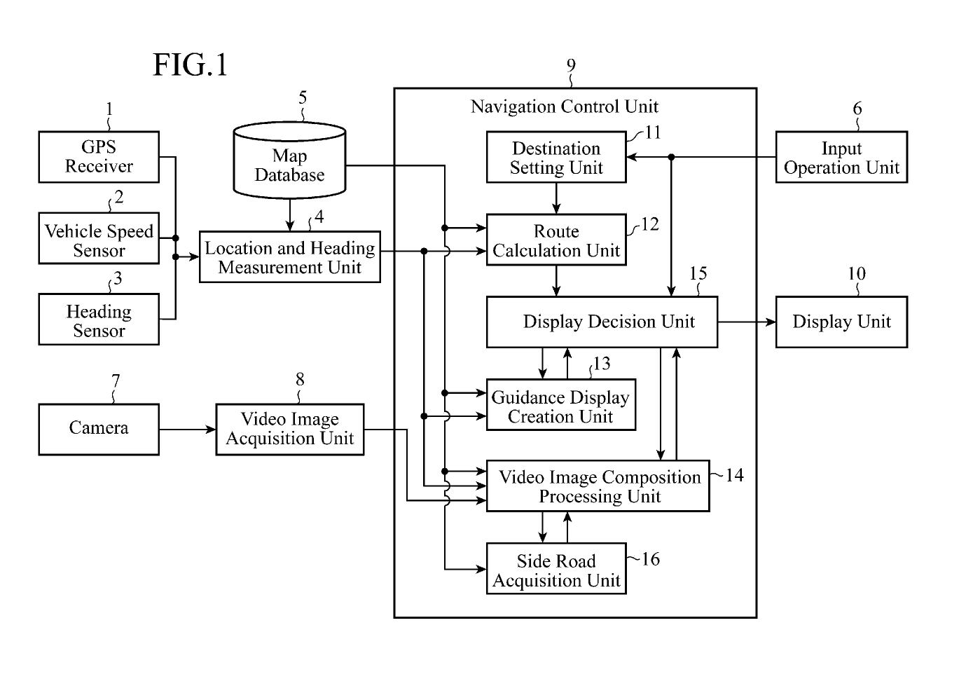

FIG. 1 is a block diagram illustrating the configuration of a navigation device according to Embodiment 1 of the present invention, in particular a car navigation device used in a vehicle. The car navigation device includes a GPS (Global Positioning System) receiver 1, a vehicle speed sensor 2, a heading sensor (rotation sensor) 3, a location and heading measurement unit 4, a map database 5, an input operation unit 6, a camera 7, a video image acquisition unit 8, a navigation control unit 9 and a display unit 10.

The GPS receiver 1 measures a vehicle location by receiving radio waves from a plurality of satellites. The vehicle location measured by the GPS receiver 1 is sent as a vehicle location signal to the location and heading measurement unit 4. The vehicle speed sensor 2 sequentially measures the speed of the vehicle. The vehicle speed sensor 2 is generally composed of a sensor that measures tire revolutions. The speed of the vehicle measured by the vehicle speed sensor 2 is sent as a vehicle speed signal to the location and heading measurement unit 4. The heading sensor 3 sequentially measures the travel direction of the vehicle. The traveling heading (hereinafter, simply referred to as “heading”) of the vehicle, as measured by the heading sensor 3, is sent as a heading signal to the location and heading measurement unit 4.

The location and heading measurement unit 4 measures the current location and heading of the vehicle on the basis of the vehicle location signal sent by the GPS receiver 1. In the cases where the space over the vehicle is blocked by, for instance, a tunnel or surrounding buildings, the number of satellites from which radio waves can be received is zero or reduced to impair the reception status thereof. The current location and heading may fail to be measured on the basis of the vehicle location signal of the GPS receiver 1 alone, or the precision of that measurement may be deteriorated. Therefore, the vehicle location is measured to carry out processing for compensating measurements performed by the GPS receiver 1 by dead reckoning (autonomous navigation) using the vehicle speed signal from the vehicle speed sensor 2 and the heading signal from the heading sensor 3.

The current location and heading of the vehicle as measured by the location and heading measurement unit 4 contains various errors that arise from, for instance, impaired measurement precision due to poor reception status by the GPS receiver 1, as described above, or vehicle speed errors on account of changes in tire diameter, caused by wear and/or temperature changes, or errors attributable to the precision of the sensors themselves. The location and heading measurement unit 4, therefore, corrects the current location and heading of the vehicle, obtained by measurement and which contains errors, by map-matching using road data acquired from map data that is read from the map database 5. The corrected current location and heading of the vehicle are sent as vehicle location and heading data to the navigation control unit 9.

The map database 5 holds map data that includes road data such as road location, road type (expressway, toll road, ordinary road, narrow street and the like), restrictions relating to the road (speed restrictions, one-way traffic and the like), or number of lanes in the vicinity of an intersection, as well as data on facilities around the road. Roads are represented as a plurality of nodes and straight line links that join the nodes. Road location is expressed by recording the latitude and longitude of each node. For instance, three or more links connected in a given node indicate a plurality of roads that intersect at the location of the node. The map data held in the map database 5 is read by the location and heading measurement unit 4, as described above, and also by the navigation control unit 9.

The input operation unit 6 is composed of at least one from among, for instance, a remote controller, a touch panel, and a voice recognition device. The input operation unit 6 is operated by the user, i.e. the driver or a passenger, for inputting a destination, or for selecting information supplied by the car navigation device. The data created through operation of the input operation unit 6 is sent as operation data to the navigation control unit 9.

The camera 7 is composed of at least one from among, for instance, a camera that captures images ahead of the vehicle, or a camera capable of capturing images simultaneously over a wide range of directions, for instance, all-around the vehicle. The camera 7 captures images of the surroundings of the vehicle, including the travel direction of the vehicle. The video signal obtained through capturing by the camera 7 is sent to the video image acquisition unit 8.

The video image acquisition unit 8 converts the video signal sent by the camera 7 into a digital signal that can be processed by a computer. The digital signal obtained through conversion by the video image acquisition unit 8 is sent as video data to the navigation control unit 9.

The navigation control unit 9 carries out data processing in order to provide a function for displaying a map of the surroundings of the vehicle in which the car navigation device is provided, wherein the function may include calculating a guidance route up to a destination inputted via the input operation unit 6, creating guidance information in accordance with the guidance route and the current location and heading of the vehicle, or creating a guide map that combines a map of the surroundings of the vehicle location and a vehicle mark that denotes the vehicle location; and a function of guiding the vehicle to the destination. In addition, the navigation control unit 9 carries out data processing for searching information such as traffic information, sightseeing sites, restaurants, shops and the like relating to the destination or to the guidance route, and for searching facilities that match the conditions inputted through the input operation unit 6. The navigation control unit 9 is explained in detail below. The display data obtained through processing by the navigation control unit 9 is sent to the display unit 10.

The display unit 10 is composed of, for instance, an LCD (Liquid Crystal Display), and displays the display data sent by the navigation control unit 9 in the form of, for instance, a map and/or a live-action vide image on the screen.

The navigation control unit 9 is explained in detail below. The navigation control unit 9 is composed of a destination setting unit 11, a route calculation unit 12, a guidance display creation unit 13, a video image composition processing unit 14, a display decision unit 15 and a side road acquisition unit 16. To prevent cluttering, some of the connections between the various constituent elements above have been omitted in FIG. 1. The omitted portions will be explained as they appear.

The destination setting unit 11 sets a destination in accordance with the operation data sent by the input operation unit 6. The destination set by the destination setting unit 11 is sent as destination data to the route calculation unit 12. The route calculation unit 12 calculates a guidance route up to the destination on the basis of destination data sent by the destination setting unit 11, vehicle location and heading data sent by the location and heading measurement unit 4, and map data read from the map database 5. The guidance route calculated by the route calculation unit 12 is sent as guidance route data to the display decision unit 15.

In response to an instruction by the display decision unit 15, the guidance display creation unit 13 creates a guide map (hereinafter, referred to as “chart-guide map”) based on a chart used in conventional car navigation devices. The chart-guide map created by the guidance display creation unit 13 includes various guide maps that do not utilize live-action video images, for instance, planimetric maps, intersection close-up maps, highway schematic maps and the like. The chart-guide map is not limited to a planimetric map, and may be a guide map employing three-dimensional CG, or a guide map that is a bird's-eye view of a planimetric map. Techniques for creating a chart-guide map are well known, and a detailed explanation thereof will be omitted. The chart-guide map created by the guidance display creation unit 13 is sent as chart-guide map data to the display decision unit 15.

In response to an instruction by the display decision unit 15, the video image composition processing unit 14 creates a guide map that uses a live-action video image (hereinafter, referred to as “live-action guide map”). For instance, the video image composition processing unit 14 acquires, from the map data read from the map database 5, information on nearby objects around the vehicle such as road networks, landmarks and intersections, and creates a content-composed video image in which there are overlaid a graphic for describing the shape, purport and the like of nearby objects as well as character strings, images and the like (hereinafter, referred to as “content”) around the nearby objects that are present in a live-action video image that is represented by the video data sent by the video image acquisition unit 8.

Also, the video image composition processing unit 14 issues an instruction to the effect of acquiring road data (road link) of side roads with respect to the side road acquisition unit 16; creates content of side road shape denoted by the side road data sent by the side road acquisition unit 16 in response to the above instruction; and creates a content-composed video image by overlaying the created content onto a live-action video image (as described in detail below). The content-composed video image created by the video image composition processing unit 14 is sent as live-action guide map data to the display decision unit 15.

As described above, the display decision unit 15 instructs the guidance display creation unit 13 to create a chart-guide map, and instructs the video image composition processing unit 14 to create a live-action guide map. Additionally, the display decision unit 15 decides the content to be displayed on the screen of the display unit 10 on the basis of vehicle location and heading data sent by the location and heading measurement unit 4, map data of the vehicle surroundings read from the map database 5, operation data sent by the input operation unit 6, chart-guide map data sent by the guidance display creation unit 13 and live-action guide map data sent by the video image composition processing unit 14. The data corresponding to the display content decided by the display decision unit 15 is sent as display data to the display unit 10.

In such a way, on the basis of the display data, the display unit 10 displays, for instance, an intersection close-up view, when the vehicle approaches an intersection, or displays a menu when a menu button of the input operation unit 6 is pressed, or displays a live-action guide map, using a live-action video image, when a live-action display mode is set by the input operation unit 6. Switching to a live-action guide map that uses a live-action video image can be configured to take place also when the distance to an intersection at which the vehicle is to turn is equal to or smaller than a given value, in addition to the case that a live-action display mode is set.

Also, the guide map displayed on the screen of the display unit 10 can be configured so as to display simultaneously, in one screen, a live-action guide map and a chart-guide map such that the chart-guide map (for instance, a planimetric map) created by the guidance display creation unit 13 is disposed on the left of the screen, and a live-action guide map (for instance, an intersection close-up view using a live-action video image) created by the video image composition processing unit 14 is disposed on the right of the screen.

In response to an instruction from the video image composition processing unit 14, the side road acquisition unit 16 acquires data on a side road connected at a location between the current location of the vehicle on the guidance route and a guidance waypoint, for instance, an intersection to which the vehicle is guided. More specifically, the side road acquisition unit 16 acquires guidance route data from the route calculation unit 12, via the video image composition processing unit 14, and acquires, from the map data read from the map database 5, data on a side road connected to the guidance route denoted by the acquired guidance route data. The side road data acquired by the side road acquisition unit 16 is sent to the video image composition processing unit 14.

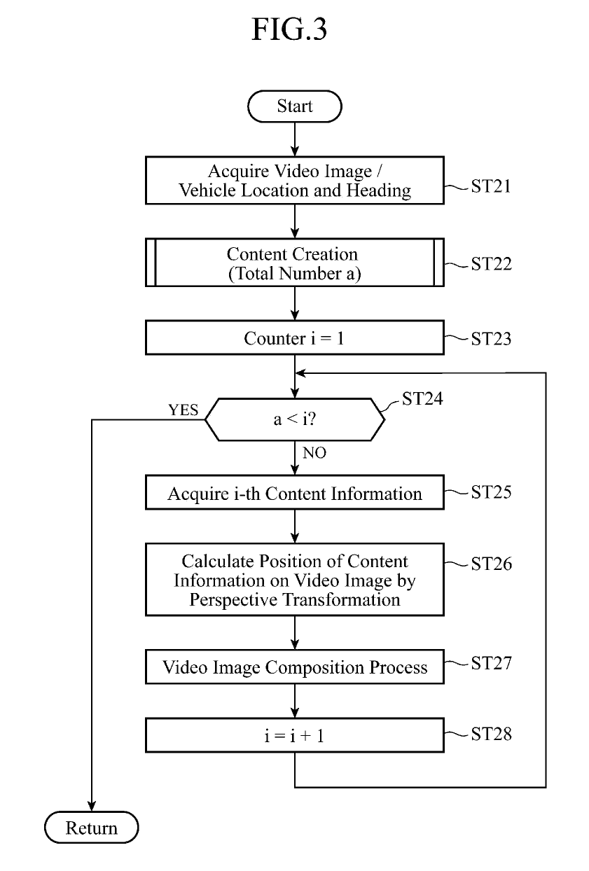

Next, with reference to the flowchart illustrated in FIG. 3, the operation of the car navigation device according to Embodiment 1 of the present invention having the above configuration will be explained with focusing on a vehicle surroundings information display process. In the vehicle surroundings information display process there is created a vehicle surroundings map, as a chart-guide map, resulting from overlaying a graphic (vehicle mark) denoting the vehicle location onto a map of the surroundings of the vehicle, and there is created also a content-composed video (described in detail below), as a live-action guide map, in accordance with the motion of the vehicle, such that the vehicle surroundings map and the content-composed video are combined and the result is displayed on the display unit 10.

In the vehicle surroundings information display process there is checked first whether vehicle surroundings information display is over or not (step ST11). Specifically, the navigation control unit 9 determines whether the input operation unit 6 has instructed termination of vehicle surroundings information display. The vehicle surroundings information display process is completed when in step ST11 it is determined that vehicle surroundings information display is over. On the other hand, when in step ST11 it is determined that vehicle surroundings information display is not over, the vehicle location and heading is then acquired (step ST12). Specifically, the navigation control unit 9 acquires vehicle location and heading data from the location and heading measurement unit 4.

Then, a vehicle surroundings map is created (step ST13). Specifically, the guidance display creation unit 13 of the navigation control unit 9 searches in the map database 5 for map data of the vehicle surroundings in the scale that is set at that point in time on the basis of the vehicle location and heading data acquired in step ST12. A vehicle surroundings map is created then that composes a vehicle mark denoting vehicle location and heading onto a map represented by the map data obtained in the search.

Additionally, the destination is set and the guidance route is calculated, respectively, in the destination setting unit 11 and the route calculation unit 12 of the navigation control unit 9. When guidance to the destination requires a left or right turn, the guidance display creation unit 13 further creates a vehicle surroundings map that combines a graphic such as an arrow for indicating the road that the vehicle has to travel (hereinafter, referred to as “route guide arrow”) overlaid onto the vehicle surroundings map.

Then, the content-composed video image creation process is carried out (step ST14). Specifically, the video image composition processing unit 14 of the navigation control unit 9 searches for information on nearby objects around the vehicle from among map data read from the map database 5, and creates a content-composed video image in which content on the shape of a nearby object is overlaid around that nearby object in a video image of the surroundings of the vehicle acquired by the video image acquisition unit 8. The particulars of the content-composed video image creation process of step ST14 will be explained in detail further below.

Then, a display creation process is carried out (step ST15). Specifically, the display decision unit 15 of the navigation control unit 9 creates display data per one screen by combining a chart-guide map including the vehicle surroundings map created by the guidance display creation unit 13 in step ST13, and the live-action guide map including the content-composed video image created by the video image composition processing unit 14 instep ST14. The created display data is sent to the display unit 10, whereby the chart-guide map and the live-action guide map are displayed on the screen of the display unit 10. Thereafter, the sequence returns thereafter to step ST11, and the above-described process is repeated.

Next, the details of the content-composed video image creation process that is carried out in step ST14 in the vehicle surroundings information display process will be described with reference to the flowchart illustrated in FIG. 3. The content-composed video image creation process is carried out mainly by the video image composition processing unit 14.

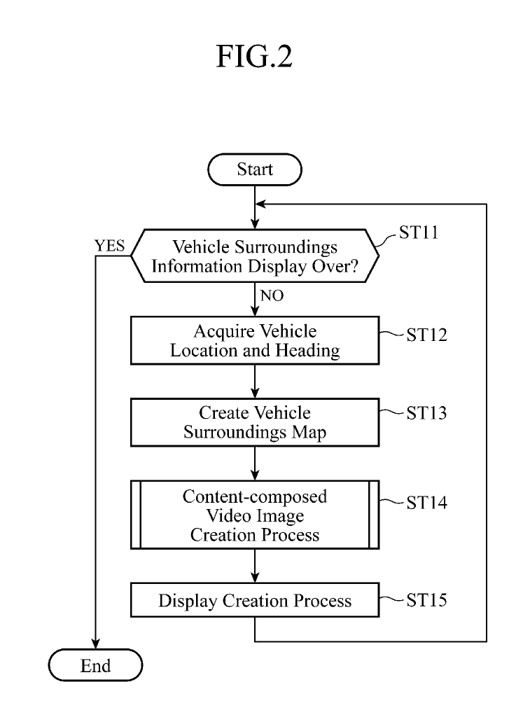

In the content-composed video image creation process, a video image as well as the vehicle location and heading are acquired first (step ST21). Specifically, the video image composition processing unit 14 acquires vehicle location and heading data acquired in step ST12 of the vehicle surroundings information display process (FIG. 2), as well as video data created at that point in time by the video image acquisition unit 8.

Then, content creation is carried out (step ST22). Specifically, the video image composition processing unit 14 searches for nearby objects of the vehicle on the basis of map data read from the map database 5, and creates, from among the searched nearby objects, content information that is to be presented to the user. The content information is stored in a content memory (not shown) in the video image composition processing unit 14. In case of guidance to a destination by indicating left and right turns to the user, the content information includes, for instance, a character string with the name of the intersection, the coordinates of the intersection, and the coordinates of a route guide arrow. When the vehicle is to be guided to a famous (noteworthy) landmark in the surroundings of the vehicle is to be indicated, the content information includes, for instance, a character string or pictures with information relating to the landmark, such as a character string with the name of the landmark, the coordinates of the landmark, as well as history, highlights, opening times and the like relating to the landmark. It is noted that in addition to the above, the content information may also include coordinates on the road network that surrounds the vehicle, and map information on, for instance, number of lanes and traffic restriction information, such as one-way traffic, or prohibited entry, for each road of the road network around the vehicle. The particulars of the content creation process that is carried out in step ST22 are explained in more detail below.

It is noted that the coordinates in the content information are given by a coordinate system (hereinafter, referred to as “reference coordinate system”) that is uniquely determined on the ground, for instance, latitude and longitude. In step ST22 there is decided the content to be presented to the user, as well as the total number of contents a.

Then, the value i of the counter is initialized (step ST23). That is, the value i of the counter for counting the number of contents already composed is set to “1”. The counter is provided inside the video image composition processing unit 14.

Then, it is checked whether the composition process is over for all the content information (step ST24). Specifically, the video image composition processing unit 14 determines whether or not the number of contents i already composed, which is the value of the counter, is greater than the total number of contents a. When in step ST24 it is determined that the composition process is over for all the pieces of content information, that is, the number of contents i already composed is greater than the total number of contents a, the content-composed video image creation process is completed, and the sequence returns to the vehicle surroundings information display process.

On the other hand, when in step ST24 it is determined that the composition process is not over for all the pieces of content information, that is, the number of contents i already composed is not greater than the total number of contents a, there is acquired i-th content information (step ST25). Specifically, the video image composition processing unit 14 acquires an i-th content information from among the content information created in step ST22.

Then, there is calculated the location of the content information on the video image through perspective transformation (step ST26). Specifically, the video image composition processing unit 14 calculates the location of the content information acquired in step ST25, in the reference coordinate system in which the content is to be displayed, on the basis of the vehicle location and heading acquired in step ST21 (location and heading of the vehicle in the reference coordinate system); the location and heading of the camera 7 in the coordinate system referenced to the vehicle; and characteristic values of the camera 7 acquired beforehand, such as field angle and focal distance. The above calculation is identical to a coordinate transform calculation called perspective transformation.

Then, a video image composition process is carried out (step ST27). Specifically, the video image composition processing unit 14 composes a content such as graphics character strings or images denoted by the content information acquired in step ST25 at the locations calculated in step ST26 on the video image acquired in step ST21.

Then, the value i of the counter is incremented (step ST28). Specifically, the video image composition processing unit 14 increments (+1) the value of the counter. The sequence returns thereafter to step ST24, and the above-described process is repeated.

It is noted that the above-described video image composition processing unit 14 is configured so as to compose content onto the video image using a perspective transformation, but may also be configured so as to recognize targets within the video image by subjecting the video image to an image recognition process, and by composing content onto the recognized video image.

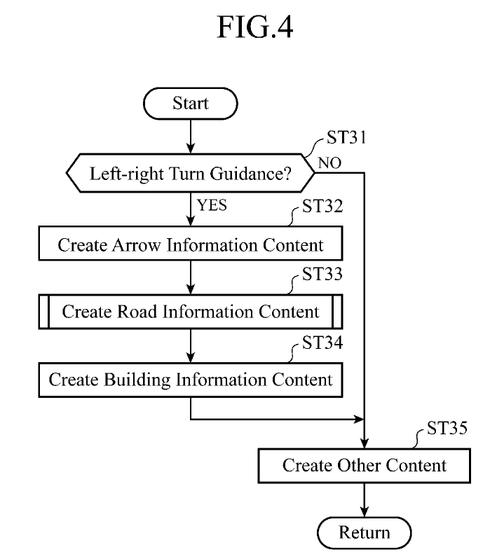

Next, the details of the content creation process that is carried out in step ST22 of the above-described content-composed video image creation process (FIG. 3) will be explained with reference to the flowchart illustrated in FIG. 4.

In the content creation process it is checked first whether the vehicle is in left-right turn guidance (step ST31). Specific conditions for deciding whether the vehicle is in left-right turn guidance include, for instance, that a guidance route up to a destination set by the user is searched through calculation by the route calculation unit 12, and that the vehicle has reached the periphery of the intersection, along the searched guidance route, at which the vehicle is to turn left or right. The “periphery of the intersection” is, for instance, a range set by the user or the manufacturer or the car navigation device, and may be, for instance, 500 m before the intersection.

When in step ST31 it is determined that the vehicle is not in left-right turn guidance, the sequence proceeds to step ST35. On the other hand, when in step ST31 it is determined that the vehicle is in left-right turn guidance, an arrow information content is then created (step ST32). The arrow information content denotes herein a graphic of a left-right turn guide arrow that is overlaid onto live-action video images in order to indicate to the user the direction to which to turn left or right at the waypoint where the vehicle is to turn left or right. The left-right turn guide arrow created in step ST32 is added to the content memory as a display content.

Then, a road information content is created (step ST33). Specifically, the road around the guidance route is gathered, and is added to the content memory as a display content. The content creation process of the road information to be executed in step ST33 is explained in detail below. In some cases no road information content need be created, depending on the settings of the car navigation device.

Then, a content of building information content is created (step ST34). Specifically, building information of the guidance route is gathered, and is added to the content memory as a display content. Note that gathering of the building information is not necessary, and in some cases no building information is created, depending on the settings of the car navigation device. Thereafter, the sequence proceeds to step ST35.

Other contents are created in step ST35. Specifically, there is created a content other than an arrow information content for left-right turn guidance, a road information content and a building information content. This other content is added to the content memory as a display content. Examples of contents created in step ST35 include, for instance, a toll gate image or toll gate amount during toll gate guidance. This completes the content creation process. The sequence returns to the content-composed video image creation process (FIG. 3).

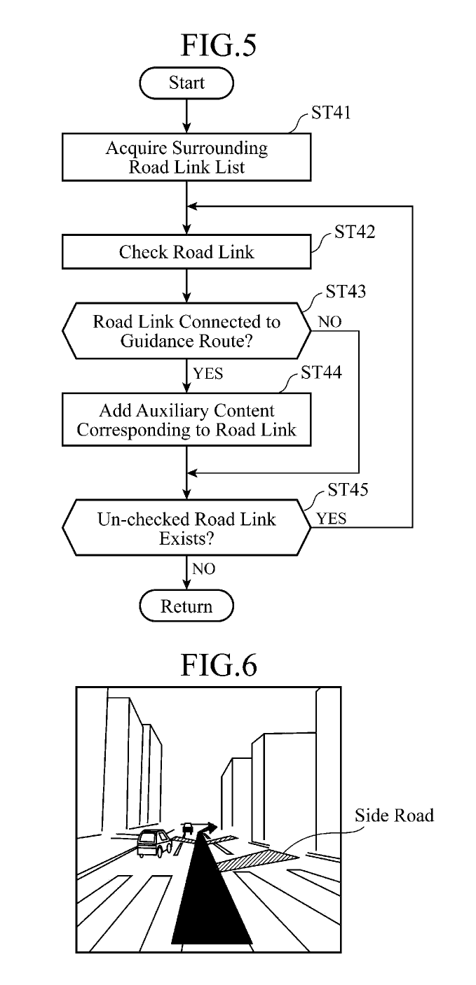

Next, with reference to the flowchart of FIG. 5, the details of the content creation process of the road information that is carried out in step ST33 of the above-described content creation process (FIG. 4) will be explained. A road link connected to the guidance route, namely, side road data, is acquired from map data around the vehicle in the content creation process of the road information, in order to facilitate grasping of the road around the guidance route, whereupon a content of the side road shape is created and is added to the content memory as a display content.

In the content creation process of the road information, there is firstly acquired a surrounding road link list (step ST41). Specifically, the video image composition processing unit 14 issues a side road acquisition instruction to the side road acquisition unit 16. In response to the instruction, the side road acquisition unit 16 acquires all the road links in a region around the vehicle from the map data read from the map database 5. The surrounding region is a region that encompasses the current location and an intersection at which the vehicle is to turn left or right, and may be, for instance, a region extending 500 (m) ahead of the vehicle and 50 (m) each to the left and right of the vehicle. At this point, all road links are yet un-checked. Data on the road link acquired by the side road acquisition unit 16 is sent to the video image composition processing unit 14.

Then, a road link is checked (step ST42). Specifically, the video image composition processing unit 14 selects and checks one un-checked road link from among the road links acquired in step ST41.

Then, it is examined whether the road link is connected to the guidance route (step ST43). Specifically, the video image composition processing unit 14 examines whether the road link selected in step ST42 is connected to the guidance route. When on the guidance route there exists a road link such that the road link shares only a single endpoint of a given road link, it is determined that the road link is connected to the guidance route. Other road links connected to a road link that is in turn directly connected to the guidance route may also be determined to be connected to the guidance route.

When in step ST43 it is determined that the road link is connected to the guidance route, there is added thereto an auxiliary content corresponding to the road link (step ST44). Specifically, there is created a content having information on side road shape from the road link that is determined to be connected to the guidance route. The side road shape information includes, for instance, the road type and the location and width of the road link in question, and contains, preferably, information that is displayed in a visually less conspicuous manner than a left-right turn guide arrow. Information that defines the displayed appearance includes, for instance, information that specifies brightness, saturation, color or translucency. Thereafter, the sequence proceeds to step ST45.

When in step ST43 it is determined that no road link is connected to the guidance route, the process of step ST44 is skipped. In step ST45 it is examined whether there is an un-checked road link. Specifically, it is examined whether there is an un-checked road link from among the road links acquired in step ST41. When in step ST45 it is determined that there exists an un-checked road link, the sequence returns to step ST42, and the above process is repeated. On the other hand, when in step ST45 it is determined that there exists no un-checked road link, the content creation process of the road information is completed, and the sequence returns to the content creation process (FIG. 4).

FIG. 6 is a diagram illustrating an example of a video image displayed on the screen of the display unit 10 by way of the above-described process, depicting existing side roads up to a guidance waypoint.

As described above, according to the car navigation device of Embodiment 1 of the present invention, when guidance information is superimposed and displayed on a video image of vehicle surroundings obtained through the capture by the camera 7, side roads (roads that intersect the road along which the vehicle is traveling) that are present up to a guidance waypoint on the guidance route, for instance, up to an intersection to which the vehicle is guided, are displayed. Therefore, it is possible to reduce the occurrence of wrong turning at an intersection ahead.

### Embodiment 2

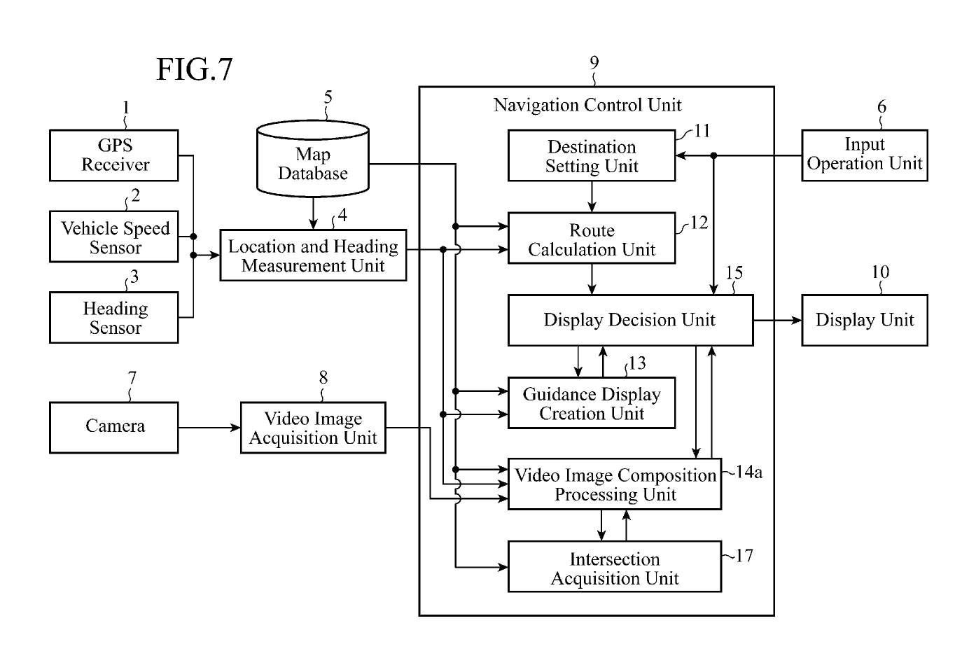

FIG. 7 is a block diagram illustrating the configuration of a car navigation device according to Embodiment 2 of the present invention. The car navigation device of the present embodiment is the car navigation device according to Embodiment 1, but herein the side road acquisition unit 16 of the navigation control unit 9 is omitted, an intersection acquisition unit 17 is added, and the video image composition processing unit 14 is changed to a video image composition processing unit 14a.

In response to an instruction from the video image composition processing unit 14a, the intersection acquisition unit 17 acquires intersection data that denotes an intersection existing on the guidance route from the vehicle location up to the intersection to which the vehicle is guided, from map data read from the map database 5. The guidance route is worked out on the basis of guidance route data acquired via the video image composition processing unit 14a from the route calculation unit 12. The intersection data acquired by the intersection acquisition unit 17 is sent to the video image composition processing unit 14a.

In addition to creating a live-action guide map in accordance with an instruction from the display decision unit 15, in the same manner as in the video image composition processing unit 14 of the car navigation device according to Embodiment 1, the video image composition processing unit 14a issues also an intersection data acquisition instruction to the intersection acquisition unit 17, creates content of the shape of a side road signboard that denotes the presence of a side road, at a location of the intersection that is denoted by the intersection data sent by the intersection acquisition unit 17, and creates a content-composed video image by overlaying the created content onto a live-action video image (as described in detail below).

Next, the operation of the car navigation device according to Embodiment 2 of the present invention having the above configuration will be described. Except for the content creation process of road information (FIG. 5), the operation of the car navigation device of Embodiment 2 is identical to that of the car navigation device of Embodiment 1. In the following, the description focuses on the differences vis-à-vis the operation of the car navigation device according to Embodiment 1.

The content creation process of the road information in the car navigation device according to Embodiment 2 will be explained with reference to the flowchart illustrated in FIG. 5 used to explain the content creation process of the road information in the car navigation device according to Embodiment 1. In the content creation process of the road information, intersections on a guidance route are acquired, from map data of the vehicle surroundings, in order to facilitate grasping the road around the guidance route; there is created a content on the shape of side road signboards that correspond to the acquired intersections; and the content is added to the content memory as a display content.

In the content creation process of the road information, there is firstly acquired a surrounding road link list (step ST41). Then, a road link is checked (step ST42). Then, it is examined whether the road link is connected to the guidance route (step ST43). The above process is the same as that of Embodiment 1.

When in step ST43 it is determined that the road link is connected to the guidance route, there is added thereto an auxiliary content corresponding to the road link (step ST44). Specifically, there is created a content having information on side road signboards, from the road link that is determined to be connected to the guidance route. The side road signboard information includes, for instance, the location at which the road link in question intersects the guidance route, and the left-right turning direction at that location. The side road signboards are disposed adjacent to the guidance route in the form of, for instance, an arrow. The display method and display location of side road signboards are not limited to the above-described ones. For instance, left and right side roads can be displayed jointly, and the signboards can be rendered at an overhead location other than at ground level.

When in step ST43 it is determined that no road link is connected to the guidance route, the process of step ST44 is skipped. In step ST45 it is examined whether there is an un-checked road link, as in Embodiment 1. When in step ST45 it is determined that there exists an un-checked road link, the sequence returns to step ST42,and the above process is repeated. On the other hand, when in step ST45 it is determined that there exists no un-checked road link, the content creation process of the road information is completed, and the sequence returns to the content creation process (FIG. 4).

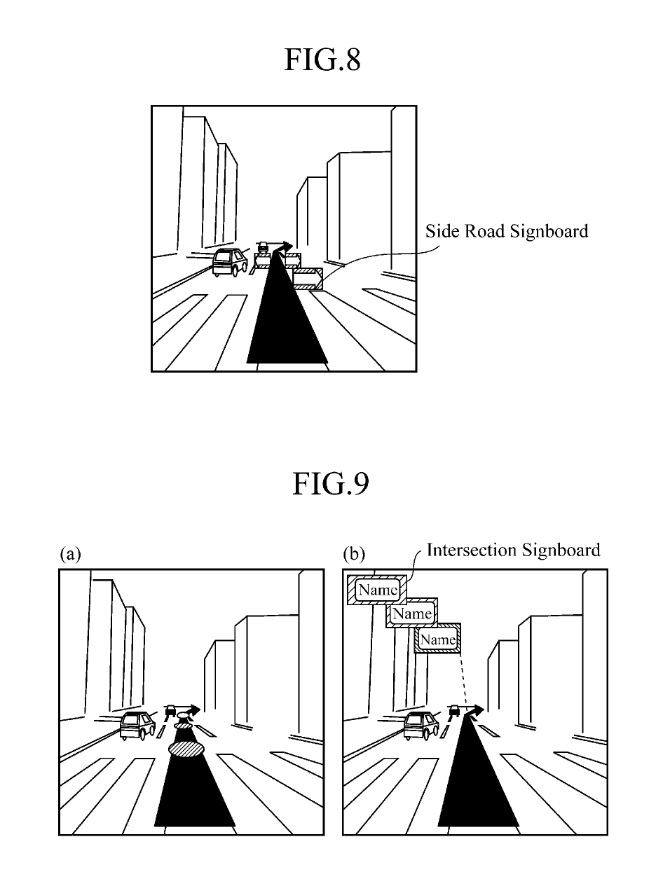

FIG. 8 is a diagram illustrating an example of a video image displayed on the screen of the display unit 10 by way of the above-described process, depicting existing side road signboards up to a guidance waypoint.

As described above, according to the car navigation device of Embodiment 2 of the present invention, when guidance information is superimposed and displayed on a video image of vehicle surroundings obtained through the capture by the camera 7, side roads existing up to a guidance waypoint, for instance, up to an intersection to which the vehicle is guided, are displayed using side road signboards. Therefore, side roads can be displayed without overlapping left and right buildings.

### Embodiment 3

The configuration of the car navigation device according to Embodiment 3 of the present invention is identical to that of Embodiment 2 illustrated in FIG. 7.

Next, the operation of the car navigation device according to Embodiment 3 of the present invention will be described. Except for the content creation process of the road information (FIG. 5), the operation of the car navigation device of Embodiment 3 is identical to that of the car navigation device of Embodiment 2. In the following, the description focuses on the differences vis-à-vis the operation of the car navigation device according to Embodiment 2.

The content creation process of the road information in the car navigation device according to Embodiment 3 will be explained with reference to the flowchart illustrated in FIG. 5 used to explain the content creation process of the road information in the car navigation device according to Embodiment 2. In the content creation process of the road information there are acquired intersections on a guidance route, from map data of the vehicle surroundings, in order to facilitate grasping the road around the guidance route; there is created a content on intersection signboards that correspond to the acquired intersections; and the content is added to the content memory as a display content.

In the content creation process of the road information, there is firstly acquired a surrounding road link list (step ST41). Then, a road link is checked (step ST42). Then, it is examined whether the road link is connected to the guidance route (step ST43). The above process is the same as that of Embodiment 2.

When in step ST43 it is determined that the road link is connected to the guidance route, there is added thereto an auxiliary content corresponding to the road link (step ST44). Specifically, there is created a content having information on intersection signboards from the road link that is determined to be connected to the guidance route. The intersection signboard information includes the location of crossings of the road link in question and the guidance route, such that the intersection signboards are disposed on the guidance route in the form of circles or the like as those illustrated in FIG. 9(a).

As illustrated in FIG. 9(b), the intersection signboard may include information such as the name of the intersection in question. In that case, the intersection signboard may be disposed at a location spaced apart from the guidance route. When intersection signboards are disposed at a location spaced apart from the guidance route, the signboards are preferably adjusted to a layout or appearance such that the order of the intersections can be discriminated. The adjustment method may involve, for instance, mutual overlapping of the intersection signboards, or gradation of brightness and saturation. The intersection signboard at an intersection at which the vehicle is to turn left or right is preferably highlighted. The highlighted display may involve, for instance, modifying the color, shape or contour trimming of only the signboard to be highlighted. Alternatively, signboards closer to the foreground than the signboard to be highlighted may be displayed in a see-through manner.

When in step ST43 it is determined that no road link is connected to the guidance route, the process of step ST44 is skipped. In step ST45 it is examined whether there is an un-checked road link, as in Embodiment 2. When in step ST45 it is determined that there exists an un-checked road link, the sequence returns to step ST42, and the above process is repeated. On the other hand, when in step ST45 it is determined that there exists no un-checked road link, the content creation process of the road information is completed, and the sequence returns to the content creation process (FIG. 4).

As described above, according to the car navigation device of Embodiment 3 of the present invention, when guidance information is superimposed and displayed on a video image of vehicle surroundings obtained through the capture by the camera 7, the presence of a side road is displayed indirectly through display of a picture of an intersection signboard that represents an intersection existing up to the guidance waypoint, instead of through explicit display of a side road existing up to the guidance waypoint. Therefore, side roads can be displayed without overlapping onto left and right buildings.

### Embodiment 4

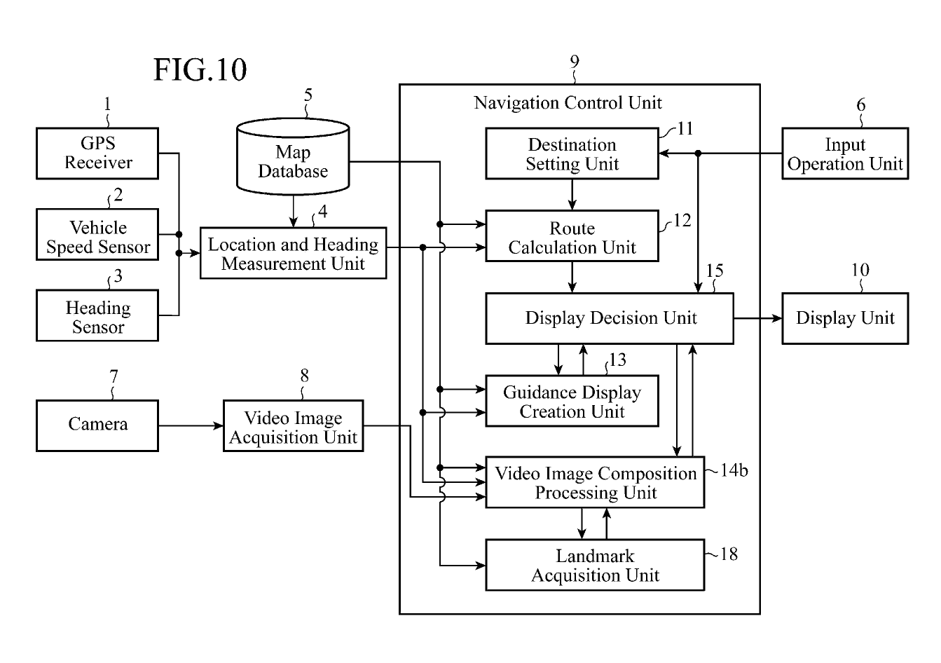

FIG. 10 is a block diagram illustrating the configuration of a car navigation device according to Embodiment 4 of the present invention. In the present car navigation device, the side road acquisition unit 16 is removed from the navigation control unit 9 of the car navigation device according to Embodiment 1, and a landmark acquisition unit 18 is added thereto. Further, the video image composition processing unit 14 is changed to a video image composition processing unit 14b.

In response to an instruction from the video image composition processing unit 14b, the landmark acquisition unit 18 acquires data on a landmark (building, park or the like) that is present around an intersection on the guidance route from the vehicle location up to the intersection to which the vehicle is guided from the map data read from the map database 5. More specifically, the landmark acquisition unit 18 acquires firstly intersection data denoting the intersections on the guidance route from the vehicle location up to the intersection to which the vehicle is guided, from the map data read from the map database 5. Then, the landmark acquisition unit 18 acquires, from the map data read from the map database 5, landmark data (building information) that denotes a landmark present around an intersection denoted by the intersection data. It is noted that the guidance route is worked out on the basis of guidance route data acquired via the video image composition processing unit 14b from the route calculation unit 12. The landmark data acquired by the landmark acquisition unit 18 is sent to the video image composition processing unit 14b.

In addition to creating a live-action guide map in accordance with an instruction from the display decision unit 15, in the same manner as in the video image composition processing unit 14 of the car navigation device according to Embodiment 1, the video image composition processing unit 14b issues also a landmark data acquisition instruction to the landmark acquisition unit 18. The video image composition processing unit 14b creates content of the landmark shape denoted by the landmark data sent by the landmark acquisition unit 18, and creates a content-composed video image by overlaying the created content onto a live-action video image (as described in detail below).

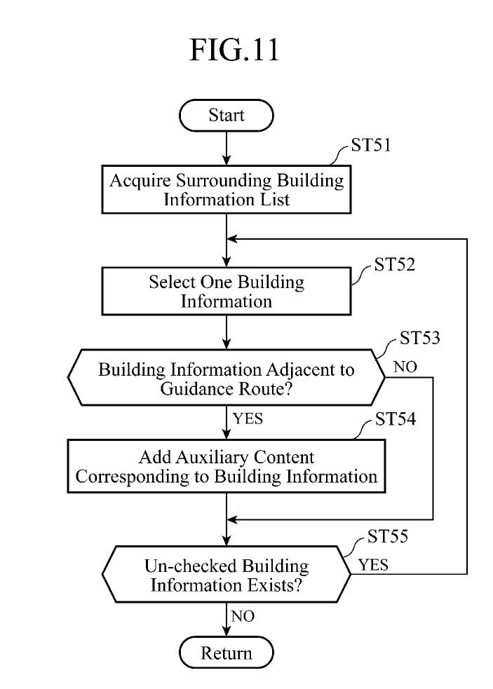

Next, the operation of the car navigation device according to Embodiment 4 of the present invention having the above configuration will be described. Except for the content creation process of road information (FIG. 5), the operation of the car navigation device of Embodiment 4 is identical to that of the car navigation device of Embodiment 1. In the following, the content creation process of the road information in the car navigation device according to Embodiment 4 will be explained with reference to the flowchart illustrated in FIG. 11.

In the content creation process of the road information there is acquired information on buildings that face the guidance route from map data of the vehicle surroundings in order to facilitate grasping the road around the guidance route. A landmark shape content is created on the basis of the acquired building information, and the content is added to the content memory as a display content.

In the content creation process of the road information, there is firstly acquired a surrounding building information list (step ST51). Specifically, the video image composition processing unit 14b issues a surrounding building information acquisition instruction to the landmark acquisition unit 18. In response to the instruction, the landmark acquisition unit 18 acquires all the pieces of building information in the surrounding region of the vehicle, from map data read from the map database 5. The surrounding region is a region that encompasses the current location and an intersection at which the vehicle is to turn left or right, and may be, for instance, a region extending 500 (m) ahead of the vehicle and 50 (m) each to the left and right of the vehicle. The region may be set beforehand by the manufacturer of the car navigation device, or may be arbitrarily set by the user. All the pieces of building information is yet un-checked at this point in time. The building information acquired by the landmark acquisition unit 18 is sent to the video image composition processing unit 14b.

Then, one item of the building information is selected (step ST52). Specifically, the video image composition processing unit 14b selects one un-checked building information item from among the building information acquired in step ST51.

Then, it is examined whether the building information is adjacent to the guidance route (step ST53). Specifically, the landmark acquisition unit 18 examines whether a building denoted by the building information selected in step ST52 is adjacent to the guidance route. To that end, a road link is searched that is close to a given building. If that road link is included in the guidance route, the building is determined to be facing the guidance route. A given building is considered to be close to a given road link when the distance between the building and the road link satisfies certain conditions, for instance, being a distance no greater than 20 (m). The distance can be set beforehand by the manufacturer of the navigation device, or may be arbitrarily set by the user.

When in step ST53 it is determined that building information is adjacent to the guidance route, an auxiliary content corresponding to the building information is added thereto (step ST54). Specifically, there is created a content having information on the shape of the landmark, from among the building information determined to be adjacent to the guidance route. The landmark shape information involves the location of the landmark. The landmark shape location is, for instance, a location overlapping the building in question. The landmark shape information may also include shapes such as shape and height of the ground of the landmark, types of facility, names, or aspects (color, texture, brightness and the like). It is noted that the aspect of a landmark shape corresponding to a building that stands near an intersection at which the vehicle is to turn left or right is preferably displayed to be distinguishable from other landmark shapes.

When in step ST53 it is determined that the building information is not adjacent to the guidance route, the process of step ST54 is skipped. In step ST55 it is examined whether there is un-checked building information. When in step ST55 it is determined that there is un-checked building information, the sequence returns to step ST52, and the above process is repeated. On the other hand, when in step ST55 it is determined that there is no un-checked building information, the content creation process of the road information is completed, and the sequence returns to the content creation process (FIG. 4).

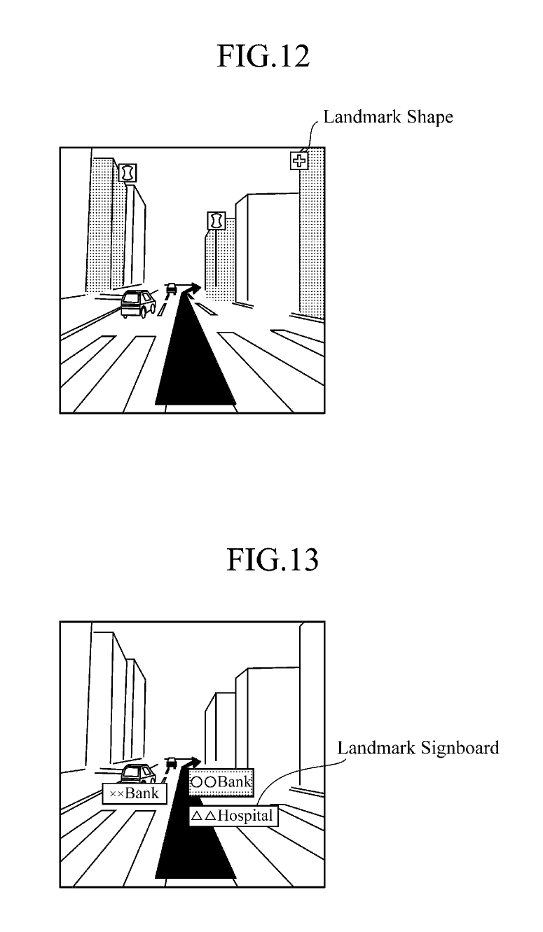

FIG. 12 is a diagram illustrating an example of a video image displayed on the screen of the display unit 10 by way of the above-described process, such that landmark shapes are depicted to be overlaid on existing buildings up to a guidance waypoint.

As described above, according to the car navigation device of Embodiment 4 of the present invention, when guidance information is superimposed and displayed on a video image of vehicle surroundings obtained through the capture by the camera 7, landmarks at the corners of intersections are displayed. This allows the user to become aware of the presence and type of landmarks to thus reduce the likelihood of wrong turning at an intersection ahead.

### Embodiment 5

The configuration of the car navigation device according to Embodiment 5 of the present invention is identical to that of Embodiment 4 illustrated in FIG. 10.

Next, the operation of the car navigation device according to Embodiment 5 of the present invention will be described. Except for the content creation process of the road information (FIG. 11), the operation of the car navigation device of Embodiment 5 is identical to that of the car navigation device of Embodiment 4. In the following, the description focuses on the differences vis-à-vis the operation of the car navigation device according to Embodiment 4.

The content creation process of the road information in the car navigation device according to Embodiment 5 will be explained with reference to the flowchart illustrated in FIG. 11 used to explain the content creation process of the road information in the car navigation device according to Embodiment 4. In the content creation process of the road information there is acquired information on the buildings that face the guidance route from map data of the vehicle surroundings in order to facilitate grasping the buildings around the guidance route, and there is created a content on the shape of landmark signboards corresponding to the acquired building information. The created content is added to the content memory as a display content.

In the content creation process of the road information, there is firstly acquired a surrounding building information list (step ST51). Then, one item of building information is selected (step ST52). Then, it is examined whether the building information is adjacent to a guidance route (step ST53). The above process is the same as that of Embodiment 4.

When in step ST53 it is determined that building information is adjacent to the guidance route, an auxiliary content corresponding to the building information is added (step ST54). Specifically, there is created a content having information on landmark signboards, from among the building information determined to be adjacent to the guidance route. The landmark signboard information here involves the location of the landmark. The location of the landmark signboard can be set to, for instance, the waypoint closest to the building in question in the guidance route. Alternatively, the landmark signboard information may also include shape, such as rectangular shape, size or contour trimming, as well as type of facility, name, or aspect (color, texture, brightness and the like). The aspect of a landmark signboard corresponding to a building that stands near an intersection at which the vehicle is to turn left or right is preferably such that the landmark signboard is displayed to be distinguishable from other landmark signboards.

When in step ST53 it is determined that the building information is not adjacent to the guidance route, the process of step ST54 is skipped. In step ST55 it is examined whether there is un-checked building information, as in Embodiment 4. When in step ST55 it is determined that there is un-checked building information, the sequence returns to step ST52, and the above process is repeated. On the other hand, when in step ST55 it is determined that there is no un-checked building information, the content creation process of the road information is completed, and the sequence returns to the content creation process (FIG. 4).

FIG. 13 is a diagram illustrating an example of a video image displayed on the screen of the display unit 10 by way of the above-described process, wherein the shape of a landmark signboard is depicted on the road so as not to overlap any buildings up to the guidance waypoint.

As described above, according to the car navigation device of Embodiment 5 of the present invention, when guidance information is superimposed and displayed on a video image of vehicle surroundings obtained through the capture by the camera 7, landmarks are displayed with shapes of landmark signboards. This allows the user to become aware of the presence and type of landmarks to thus reduce the likelihood of wrong turning at an intersection ahead.

### Embodiment 6

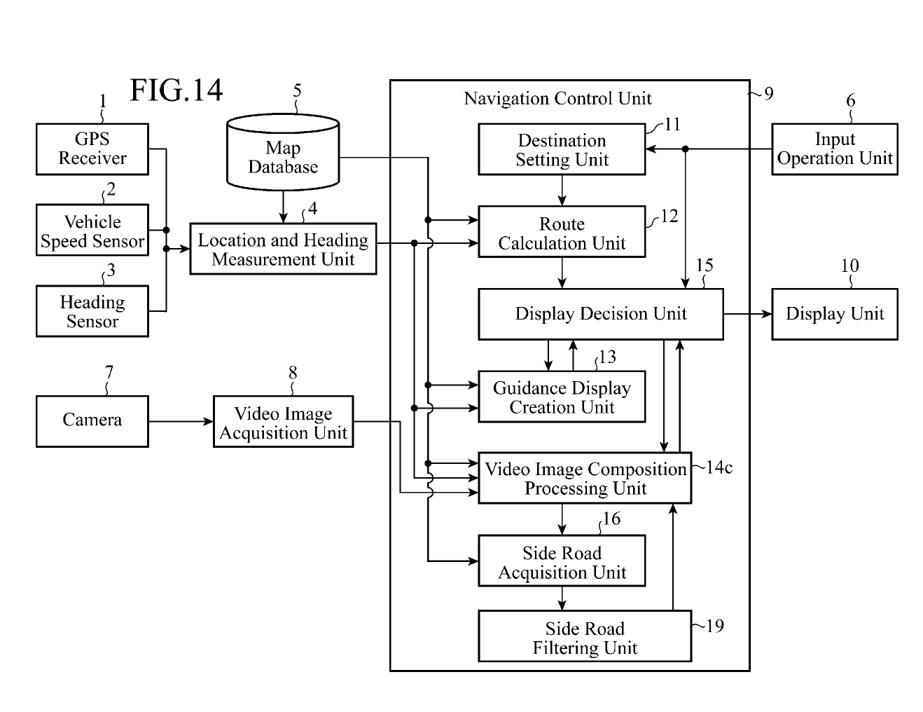

FIG. 14 is a block diagram illustrating the configuration of a car navigation device according to Embodiment 6 of the present invention. In the present car navigation device, a side road filtering unit 19 is added to the navigation control unit 9 of the car navigation device according to Embodiment 1, and the video image composition processing unit 14 is changed to a video image composition processing unit 14c.

In response to an instruction from the side road acquisition unit 16, the side road filtering unit 19 executes a filtering process in which side roads not required for guidance, from among the side roads, the data on which is acquired by the side road acquisition unit 16 are selected and eliminated. The elimination method may involve, for instance, comparing the angle of a side road relative to the direction in which the vehicle is to turn left or right at the intersection to which the vehicle is guided, and eliminating, as unnecessary side roads, those roads whose angle that lies outside a range from 90 degrees to minus 90 degrees. There may also be used a method that eliminates one-way traffic roads into which the vehicle cannot enter, or side roads that run in a reverse direction to the direction in which the vehicle is to turn left or right. A combination of the above methods may also be used. The side road data after filtering by the side road filtering unit 19 is sent to the video image composition processing unit 14c.

In addition to creating a live-action guide map in accordance with an instruction from the display decision unit 15, in the same manner as in the video image composition processing unit 14 of the car navigation device according to Embodiment 1, the video image composition processing unit 14c issues an instruction to the effect of acquiring road data (road link) of side roads to the side road acquisition unit 16; creates a content of side road shape denoted by the side road data sent from the side road acquisition unit 16 in response to the above instruction; and creates a content-composed video image by overlaying the created content onto a live-action video image (as described in detail below).

Next, the operation of the car navigation device according to Embodiment 6 of the present invention having the above configuration will be described. Except for the content creation process of road information (FIG. 5), the operation of the car navigation device of Embodiment 6 is identical to that of the car navigation device of Embodiment 1. In the following, the description below focuses on the differences vis-à-vis the operation of the car navigation device according to Embodiment 1.

The content creation process of the road information in the car navigation device according to Embodiment 6 will be explained with reference to the flowchart illustrated in FIG. 5 used to explain the content creation process of the road information in the car navigation device according to Embodiment 1. In the content creation process of the road information, there are acquired only road links that are necessary for guidance from among the road links connected to the guidance route, from map data of the vehicle surroundings, in order to facilitate grasping the road around the guidance route. A content of the side road shape is created on the basis of the acquired road links, and is added to the content memory as a display content.

In the content creation process of the road information, there is firstly acquired a surrounding road link list (step ST41). Then, a road link is checked (step ST42). Then, it is examined whether the road link is connected to the guidance route (step ST43). Then, the above process is the same as that of Embodiment 1.

When in step ST43 it is determined that the road link is connected to the guidance route, there is added thereto an auxiliary content corresponding to the road link (step ST44). Specifically, when the road link determined to be connected to the guidance route is not a road link eliminated by the side road filtering unit 19, there is created a content having side road shape information from the road link. Thereafter, the sequence proceeds to step ST45.

When in step ST43 it is determined that no road link is connected to the guidance route, the process of step ST44 is skipped. In step ST45 it is examined whether there is an un-checked road link, as in Embodiment 1. When in step ST45 it is determined that there exists an un-checked road link, the sequence returns to step ST42, and the above process is repeated. On the other hand, when in step ST45 it is determined that there exists no un-checked road link, the content creation process of the road information is completed, and the sequence returns to the content creation process (FIG. 4).

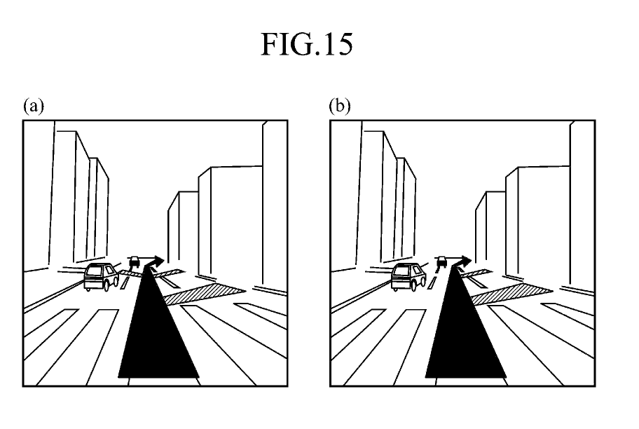

FIG. 15 is a set of diagrams illustrating an example of a video image displayed on the screen of the display unit 10 by way of the above-described process. FIG. 15(a) is a diagram illustrating an example of a video image displayed on the screen of the display unit 10 by the car navigation device according to Embodiment 1, in which all side roads are displayed. FIG. 15(b) is a diagram illustrating an example of a video image displayed on the screen of the display unit 10 by the car navigation device according to Embodiment 6, in which side roads running in an inverse direction to the direction at which the vehicle is to turn right are filtered, and only the side roads in the same direction as the right-turn direction are displayed.

As described above, according to the car navigation device of Embodiment 6 of the present invention, when guidance information is superimposed and displayed on a video image of vehicle surroundings obtained through the capture by the camera 7, a filtering process is carried out in the case that there are easily confused side roads to display, for instance, only side roads in a turning direction. Thus, unnecessary guidance can be suppressed.

### Embodiment 7

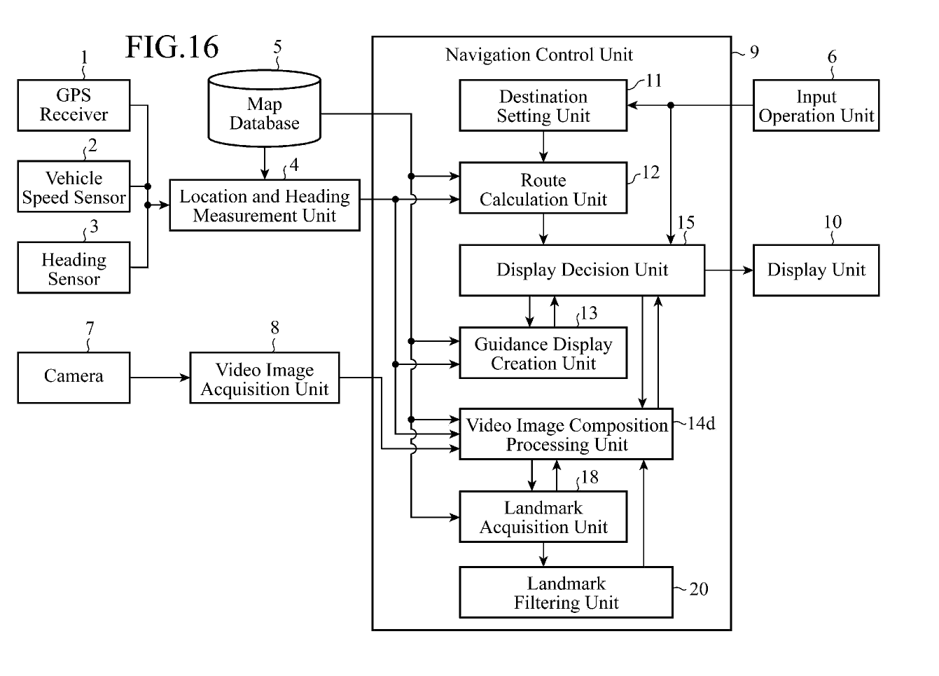

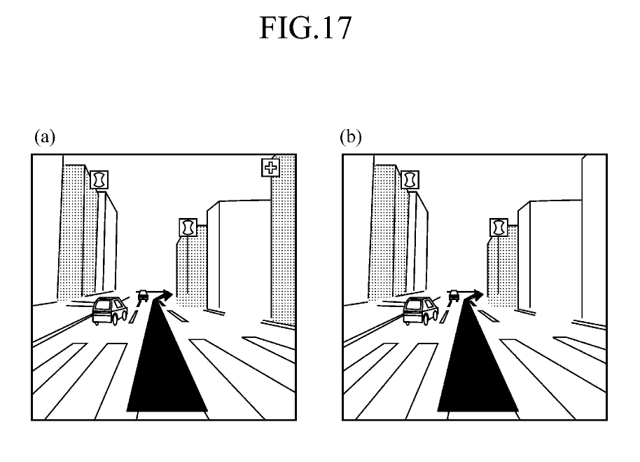

FIG. 16 is a block diagram illustrating the configuration of a car navigation device according to Embodiment 7 of the present invention. In the present car navigation device, a landmark filtering unit 20 is added to the navigation control unit 9 of the car navigation device according to Embodiment 4, and the video image composition processing unit 14b is changed to a video image composition processing unit 14d.

In response to an instruction from the landmark acquisition unit 18, the landmark filtering unit 20 executes a filtering process in which there are eliminated those landmarks that are not required for guidance from among the landmarks acquired by the landmark acquisition unit 18. The elimination method may involve, for instance, not adding to content those landmark shapes whose facility type differs from landmarks close to an intersection at which the vehicle is to turn left or right. After being filtered by the landmark filtering unit 20, the landmark data is sent to the video image composition processing unit 14d.

In addition to creating a live-action guide map in accordance with an instruction from the display decision unit 15, in the same manner as in the video image composition processing unit 14 of the car navigation device according to Embodiment 1, the video image composition processing unit 14d issues also a landmark data acquisition instruction to the landmark acquisition unit 18. The video image composition processing unit 14d creates content of the landmark shape denoted by the filtered landmark data sent by the landmark acquisition unit 18, and creates a content-composed video image by overlaying the created content onto a live-action video image (as described in detail below).

Next, the operation of the car navigation device according to Embodiment 7 of the present invention having the above configuration will be described. Except for the content creation process of road information (FIG. 11), the operation of the car navigation device of Embodiment 7 is identical to that of the car navigation device of Embodiment 4. In the following, the description focuses on the differences vis-à-vis the operation of the car navigation device according to Embodiment 4.

The content creation process of the road information in the car navigation device according to Embodiment 7 will be explained with reference to the flowchart illustrated in FIG. 11 used to explain the content creation process of the road information in the car navigation device according to Embodiment 4. In the content creation process of the road information there is acquired information on the buildings that face the guidance route from a map data of the vehicle surroundings in order to facilitate grasping the road around the guidance route. A landmark shape content is created on the basis of the acquired building information, and the created content is added to the content memory as a display content.

In the content creation process of the road information, there is firstly acquired a surrounding building information list (step ST51). Then, one item of building information is selected (step ST52). Then, it is examined whether the building information is adjacent to a guidance route (step ST53). The above process is the same as that of Embodiment 4.

When in step ST53 it is determined that building information is adjacent to the guidance route, an auxiliary content corresponding to the building information is added (step ST54). Specifically, when the building information determined to be adjacent to the guidance route is not building information eliminated by the landmark filtering unit 20, there is created a content having landmark shape information, from the building information. Thereafter, the sequence proceeds to step ST55.

When in step ST53 it is determined that the building information is not adjacent to the guidance route, the process of step ST54 is skipped. In step ST55 it is examined whether there is un-checked building information, as in Embodiment 4. When in step ST55 it is determined that there is un-checked building information, the sequence returns to step ST52, and the above process is repeated. On the other hand, when in step ST55 it is determined that there is no un-checked building information, the content creation process is completed, and the sequence returns to the content creation process (FIG. 4).

FIG. 17 is a set of diagrams illustrating an example of a video image displayed on the screen of the display unit 10 as a result of the above-described process. FIG. 17(a) is a diagram illustrating an example of a video image displayed on the screen of the display unit 10 by the car navigation device according to Embodiment 4, in which all the landmark shapes are displayed. FIG. 17(b) is a diagram illustrating an example of a video image displayed on the screen of the display unit 10 by the car navigation device according to Embodiment 7, in which there are displayed only landmark shapes of the same type as a landmark adjacent to the intersection at which the vehicle is to turn left or right.

As described above, according to the car navigation device of Embodiment 7 of the present invention, when guidance information is superimposed and displayed on a video image of vehicle surroundings obtained through the capture by the camera 7, a filtering process is carried out to thus display only landmarks of a same type in the case that there are easily confused side roads. Unnecessary guidance can be suppressed.

A car navigation device for use in vehicles is explained in the embodiments illustrated in the figures. However, the car navigation device according to the present invention can also be used in a similar manner with respect to other mobile objects such as a cell phone equipped with a camera or an airplane.

### INDUSTRIAL APPLICATION

In the navigation device according to the present invention, as described above, there are displayed side roads that are present on a guidance route up to a guidance waypoint, during display of guidance information that is overlaid onto a vehicle surroundings video image captured by a camera. As a result, side roads can be displayed in an easy to grasp manner, and the likelihood of wrong turning at an intersection ahead is reduced. The navigation device according to the present invention can be suitably used thus in car navigation devices and the like.

1.-7. (canceled)

8. A navigation device, comprising:
a map database that holds map data;
a location and heading measurement unit that measures a current location and heading of a vehicle;
a route calculation unit that, based on the map data read from the map database, calculates a guidance route from the current location measured by the location and heading measurement unit to a destination;
a camera that captures a video image ahead of the vehicle;
a video image acquisition unit that acquires the video image ahead of the vehicle that is captured by the camera;
an intersection acquisition unit that acquires an intersection existing between a current location of the guidance route calculated by the route calculation unit and a guidance waypoint;
a video image composition processing unit that composes a picture representing the presence of a side road onto the video image acquired by the video image acquisition unit at an intersection acquired by the intersection acquisition unit in a superimposing manner without being overlapped onto a building; and
a display unit that displays the video image composed by the video image composition processing unit.

9. The navigation device according to claim 8, wherein the video image composition processing unit composes a picture representing the intersection instead of representing the presence of the side road, onto the video image acquired by the video image acquisition unit at the location of the intersection acquired by the intersection acquisition unit in a superimposing manner without being overlapped onto a building.

10. A navigation device, comprising:
a map database that holds map data;
a location and heading measurement unit that measures a current location and heading of a vehicle;
a route calculation unit that, based on the map data read from the map database, calculates a guidance route from the current location measured by the location and heading measurement unit to a destination;
a camera that captures a video image ahead of the vehicle;
a video image acquisition unit that acquires the video image ahead of the vehicle that is captured by the camera;
a landmark acquisition unit that acquires a landmark existing around an intersection that is present between a current location of the guidance route calculated by the route calculation unit and a guidance waypoint;
a video image composition processing unit that composes a picture of the landmark acquired by the landmark acquisition unit onto the video image acquired by the video image acquisition unit in a superimposing manner; and
a display unit that displays the video image composed by the video image composition processing unit.

11. The navigation device according to claim 8, comprising a side road filtering unit that selects and eliminates a predetermined side road from among the side roads acquired by the side road acquisition unit, wherein the video image composition processing unit composes a picture representing a side road other than the side road eliminated by the side road filtering unit, from among the side roads acquired by the side road acquisition unit, onto the video images acquired by the video image acquisition unit in a superimposing manner.

12. The navigation device according to claim 10, comprising a landmark filtering unit that selects and eliminates a predetermined landmark from among the landmarks acquired by the landmark acquisition unit, wherein the video image composition processing unit composes a picture representing a landmark other than the landmarks eliminated by the landmark filtering unit, from among the landmarks acquired by the landmark acquisition unit, onto the video image acquired by the video image acquisition unit in a superimposing manner.
